(19) United States
(12) Patent Application Publication
(10) Pub. No.: US 2004/0015311 A1
(43) Pub. Date: Jan. 22, 2004

(54) Low-cost, compact, frequency domain reflectometry system for testing wires and cables

(76) Inventors: Cynthia Furse, Salt Lake City, UT (US); Nilesh Kamdar, Thousand Oaks, CA (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/043,884

(22) Filed: Jan. 9, 2002

Related U.S. Application Data
(60) Provisional application No. 60/260,507, filed on Jan. 9, 2001.
(60) Provisional application No. 60/303,676, filed on Jul. 7, 2001.

(51) Int. Cl. G01M 19/00

(52) U.S. Cl. 702/108

(57) ABSTRACT

A frequency domain reflectometer that is in electrical communication with a cable under test in order to determine cable characteristics including cable length and load characteristics such as capacitance, inductance, resistance, impedance (which is characterized as an open or short circuit condition), and the location of an open or short circuit, wherein the method of operation comprises the steps of generating an input signal, splitting the input signal to the cable under test and to a mixer, sending a reflected input signal to the mixer to thereby generate a mixed signal, removing high frequency components, digitizing a remaining component that contains information regarding impedance and length of the cable under test, performing the same steps for several different frequencies, and analyzing the plurality of digitized signals to thereby determine impedance and length of the cable under test.

### CROSS REFERENCE TO RELATED APPLICATIONS

This document claims priority to U.S. Provisional Patent Application Serial No. 60/260,507, and titled LOW-COST, COMPACT, FREQUENCY DOMAIN REFLECTOMETRY SYSTEM FOR TESTING WIRES AND CABLES, and to U.S. Provisional Patent Application Serial No. 60/303,676, and titled FREQUENCY DOMAIN REFLECTOMETRY SYSTEM FOR TESTING WIRES AND CABLES.

### BACKGROUND

1. The Field of the Invention

This invention relates generally to systems and techniques for performing wire and cable testing. More specifically, the invention teaches how to utilize the principles of frequency domain reflectometry to perform wire and cable testing including determination of wire or cable characteristics such as length, impedance (which is characterized as an open or short circuit condition), the location of an open or short circuit, capacitance, inductance, and resistance.

2. Background of the Invention

The benefits of being able to test wires and cables (hereinafter to be referred to as a cable) are many. Some reasons are obvious. For example, cables are used in many pieces of equipment that can have catastrophic results if the equipment fails. A good example of this is an airliner. However, the consequences of non-performance do not have to be so dire in order to see that benefits are still to be gained. For example, cables re used in many locations where they are difficult to reach, such as in the infrastructure of buildings and homes. Essentially, in many cases it is simply not practical to remove cable for testing, especially when this action can cause more damage than it prevents.

Given that the need for cable testing is important and in some cases imperative, the question is how to perform accurate testing that is practical, meaning relatively inexpensive and at a practical cost. The prior art describes various techniques for performing cable testing. One such technique is time domain reflectometry (TDR). TDR is performed by sending an electrical pulse down a cable, and then receiving a reflected pulse. By analyzing the reflected pulse, it is possible to determine cable length, impedance, and the location of open or short circuits.

One of the main disadvantages of TDR is that the equipment required to perform time analysis of a reflected signal is expensive and often bulky. These factors of cost and size can be critically important. A less costly and bulky system can be used in more places, more often, and can result in great savings in money spent on performing maintenance functions, and by replacing equipment before failure. But more importantly, the greatest benefit may be the saving of lives.

Consider again the airline industry. Miles and miles of cabling inside an airplane is extremely difficult to reach and test. If the cabling is removed for testing, the cabling can be damaged where no damage existed before. Thus, testing can result in more harm than good when cabling must be moved to gain access. But the nature of an airplane simply makes access with bulky testing equipment difficult. In addition, if the electronics for testing cables could remain in situ, then testing could be automated and used routinely before or after flight, or at any other time that testing was requested. This can be accomplished only with smaller, less expensive systems such as provided by frequency domain reflectometry.

It is noted that TDR is not the only prior art technique available for cable testing. In standing wave reflectometry (SWR), a signal is transmitted and a reflected signal is received at a directional coupler. The system then measure the magnitude of the reflected signal. A short circuit, an open circuit, and the depth of a null gives the same information as TDR. However, this technique is less generally accurate and nearly as expensive.

It is worth noting that the prior art sometimes refers to an FDR cable testing system. However, upon closer inspection, the system being described is actually an SWR system.

Accordingly, it would be an advantage over the prior art to provide a system for cable testing that relatively smaller and therefore usable in more locations that are otherwise more difficult to reach with state of the art cable testing equipment. It would be another advantage to provide a system that would be less costly because of the nature of the components utilized therein. It would be another advantage to provide a system that is more likely to be used because it is not as difficult to use as the prior art cable testing equipment, and can be automated for regular testing even by unskilled personnel.

The technology being applied to the problem of cable testing by the present invention has not previously been used for this purpose. Specifically, frequency domain reflectometry (FDR) is typically used in radar applications. FDR is based on single frequency radar or stepped frequency radar. It was utilized in a free-space environment where antennas are used to transmit and receive a radar signal. Thus, the results produced when used for cable testing were surprising to those skilled in the art.

### SUMMARY OF INVENTION

It is an object of the present invention to provide a system for cable testing that utilizes the principles of frequency domain reflectometry (FDR).

It is another object to provide an FDR cable testing system that is less costly than prior art cable testing equipment.

It is another object to provide an FDR cable testing system that is less bulky than prior art cable testing equipment.

It is another object to provide an FDR cable testing system that utilizes less power than prior art cable testing equipment.

In a preferred embodiment, the present invention is a frequency domain reflectometer that is in electrical communication with a cable under test in order to determine cable characteristics including cable length and load characteristics such as capacitance, inductance, resistance, impedance (which is characterized as an open or short circuit condition), and the location of an open or short circuit, wherein the method of operation comprises the steps of generating an input signal, splitting the input signal to the cable under test and to a mixer, also sending a reflected input signal to the mixer to thereby generate a mixed signal, removing or ignoring high frequency components, digitizing a remaining component that contains information regarding impedance and length of the cable under test, performing the same steps for several different frequencies, and analyzing the plurality of digitized signals to thereby determine impedance and length of the cable under test.

In a first aspect of the invention, a set of sine waves is transmitted, and a reflected signal is combined with the transmitted signal and analyzed to determine cable characteristics.

In a second aspect of the invention, the electronic circuitry can be disposed within a single integrated circuit.

In a third aspect of the invention, the FDR cable testing system provides at least the same level of accuracy as the prior art cable testing systems.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1 is a schematic block diagram illustrating an embodiment of a frequency domain reflectometry (FDR) cable testing system that is made in accordance with the principles of the present invention.

FIG. 2 is an alternative embodiment of the FDR cable testing system in the form of a schematic block diagram.

FIG. 3 is a flowchart illustrating one embodiment of a method of utilizing the FDR cable testing system as described in FIG. 1.

FIG. 4 is flowchart illustrating an embodiment of a method for conditioning a signal received from the FDR cable testing system as described in FIG. 1.

FIG. 5 is a flowchart illustrating an embodiment of a method for processing data received from the FDR cable testing system as described in FIG. 1.

### DETAILED DESCRIPTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

In the most basic principles of FDR, a set of sine waves is transmitted in a cable, and a reflected signal is then analyzed. One of the main advantages of FDR over TDR is that an FDR system only requires five distinct electronic components, and these components are relatively inexpensive. In contrast, a TDR system is approximately the size of a cigar box, and its components can cost approximately $1500. Thus, whereas the present invention can be disposed within a single integrated circuit, the TDR system is much larger. In addition, the cable testing system utilizing FDR requires much less power than the TDR system, and the cost is around $20 for the FDR system circuitry.

While FDR, TDR and SWR systems are known in the prior art, utilizing an FDR system to test cables is a novel application of the technology, and the results are unexpected.

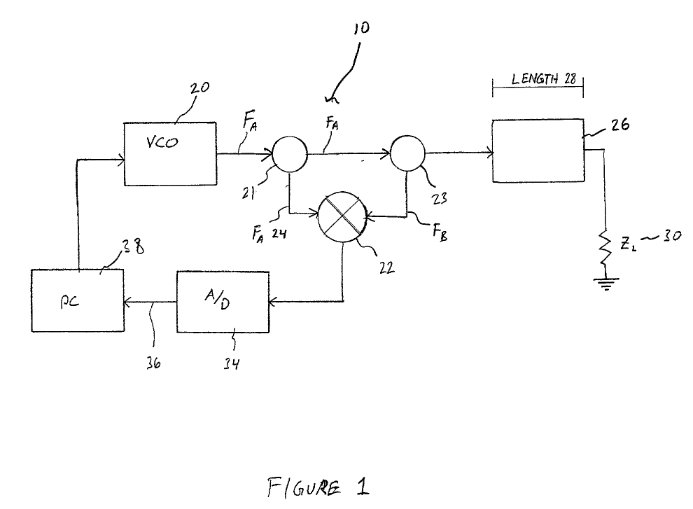

The FDR cable testing system 10 of the present invention is shown in FIG. 1. A sine wave generator such as a voltage controlled oscillator (VCO) 20 generates an input signal F_{A} in the form of sine waves. The VCO 20 feeds the input signal F_{A} down two different paths. The first path of the input signal F_{A} is into a directional coupler 21. From there, the input signal goes to a mixer 22 as a test or reference signal 24. The second path for the input signal F_{A} is into a device under test or cable under test (CUT) 26. The CUT 26 will have some characteristic load ZL 30.

While the FDR cable testing system 10 was initially designed by the inventors to detect opens and shorts in a cable, the system can also detect inductive and capacitive impedances. Thus, the characteristics of the CUT 26 that are of most interest to the present invention's function as a cable testing system are of the length 28 and of the load 30. It should be recognized that the load 30 of the CUT 26 can be complex.

When the input signal F_{A} is generated by the VCO 20, the input signal F_{A} is reflect at the load 30, and is passed back along the CUT 26. The reflected signal F_{B} is split from the CUT 26 using directional coupler 23 and is then received by the mixer 22. A combined output signal 32 is then read from the mixer 22 and sent to an analog to digital (A/D) converter 34. Because a mixer is a frequency multiplier, the combined output signal 32 of the mixer 22 has three components: the input signal F_{A}, along with F_{A}+F_{B}, and F_{A}−F_{B}. It should be apparent that the components F_{A} and F_{A}+F_{B} are going to be high frequency signals, but F_{A}−F_{B} is not. Because F_{A}=F_{B}, it is a DC signal.

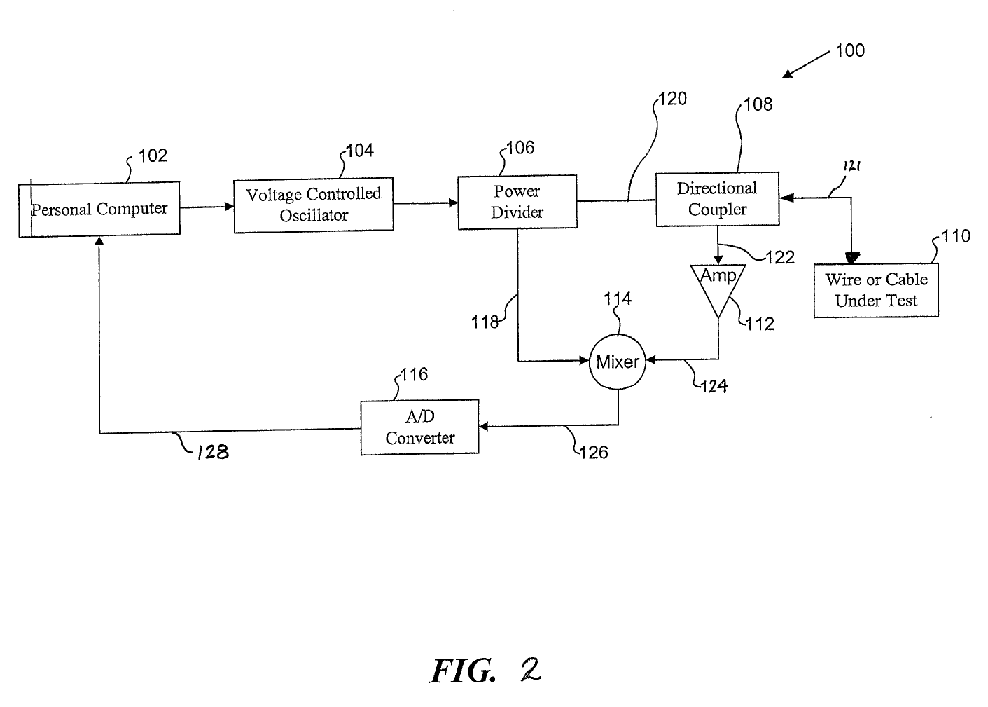

The A/D converter 34 thus automatically filters out the high frequency components F_{A} and F_{A}+F_{B} of the combined signal 32, leaving only the desired DC component F_{A}−F_{b}, which has a magnitude related to the electrical length of the CUT 26 and the load 30. The resulting signal 36 is then sent to a processor 38 such as a microcontroller or other processing system. The processor 38 must perform Fast Fourier Transform (FFT) calculations and some algebraic calculations to obtain the desired information. The function of the FFT calculations is to determine the number of cycles as a function of frequency in the digital signal generated by the A/D converter 34. The specific algebraic calculations will be shown in relation to an explanation of FIG. 2.

There are various methods that can be used to determine the number of cycles above. The FFT is a convenient system, and all of these methods are known to those skilled in the art. These methods include the Discrete Fourier Transform, the Two Equations—Two Unknowns method, N-Equations N-Uknowns, Interpolation and FFT, Interspersing Zero Points and Low Pass Filtering, Acceleration of Data Signal, Zero Crossing of Signals, and finally Mathematical Modeling.

Any of these methods can be substituted for FFT without changing the essence of the invention. These other methods are also known to those skilled in the art, and are not considered a limitation of the invention. The FFT method is simply offered in more detail in order to provide a working example.

The processor 38 generally serves another useful function other than performing the calculations that obtain the desired results. Specifically, it is desirable to use the processor 38 to control operation of the VCO 20. This is because the processor 38 can also be made capable of stepping the VCO 20 through various sets of frequencies in order to determine all of the desired characteristics of the CUT 26. In other words, several frequencies in several different frequency bands cold be analyzed using this method.

The implications of the simple circuit used in the FDR cable testing system 10 as described in FIG. 1 should not be overlooked. The FDR cable testing system 10 is capable of providing data regarding loads thereon, including open circuits, short circuits, capacitance, inductance, resistance, some very large chafes, frays, and other anomalies. As implemented, the FDR cable testing system also provides the length of the CUT 26 within approximately 3 to 7 centimeters. However, it is envisioned this range can be controlled (reduced or increased) by varying the range and resolution of the frequencies used.

FIG. 2 is an illustration of FDR cable testing system 100 providing additional detail not shown on the basic circuitry shown in FIG. 1. FIG. 1 shows that a personal computer 102 is performing the functions of controlling the generation of an input signal, as well as the function of calculating the desired information regarding a cable under test. The personal computer 102 is coupled to a sine wave generator such as the voltage-controlled oscillator 104. The VCO 104 receives a control signal in the form of an analog voltage from the personal computer 102, and generates at least one sine wave that is transmitted to the power divider 106 as an input signal. The power divider 106 is this embodiment is a 3 dB power divider. However, a 20 dB power divider or other value could be used. The power divider 106 is configured to split the input signal along two separate transmission paths 118 and 120. A mixer 114 receives the input signal transmitted along transmission path 118. The cable under test 110 receives the input signal transmitted along transmission path 120, through the directional coupler 108 and path 121.

The input signal traveling down the CUT 110 continues until a point of termination of the CUT 110 is reached. Termination of the CUT 110 is generally going to be either an open circuit or a short circuit condition, although less extreme terminations can also be evaluated.

When the input signal encounters a termination of the CUT 110, the input signal is reflected. The reflected input signal is transmitted to a directional coupler 108, and then to an amplifier 112 along transmission path 122. The reflected input signal is amplified in this embodiment so that it approximately matches the magnitude of the input signal that was transmitted to the mixer 114. After the reflected input signal has been amplified, it is also sent to the mixer 114 along transmission path 124.

It should be explained that the amplifier is optional. When the CUT 110 is long, the reflected input signal may be relatively weak when compared to the input signal. Thus, it can be beneficial to amplify it. But amplification may not be necessary.

The mixer 114 receives two signals, the input signal from the VCO 104, and the reflected input signal from the CUT 110, all of which are at the same frequency. A mixer output signal is comprised of three components: the original input signal, the sum of the input signal and the reflected input signal, and the difference between the input signal and the reflected input signal. The mixer output signal is transmitted to an A/D converter 116 along transmission path 126. The A/D converter 116 is effectively a low pass filter. The input signal and the sum of the input signal and the reflected input signal are filtered out. But the difference between the input signal and the reflected input signal is a DC voltage value, which is converted by the A/D converter 116.

After conversion of the analog mixer output signal to a digital signal, the digital signal is sent to the personal computer 102 along transmission path 128. Analysis of the digital signal received by the personal computer 102 is performed to determine a termination point of the CUT 110 in accordance with characteristics of the digital signal.

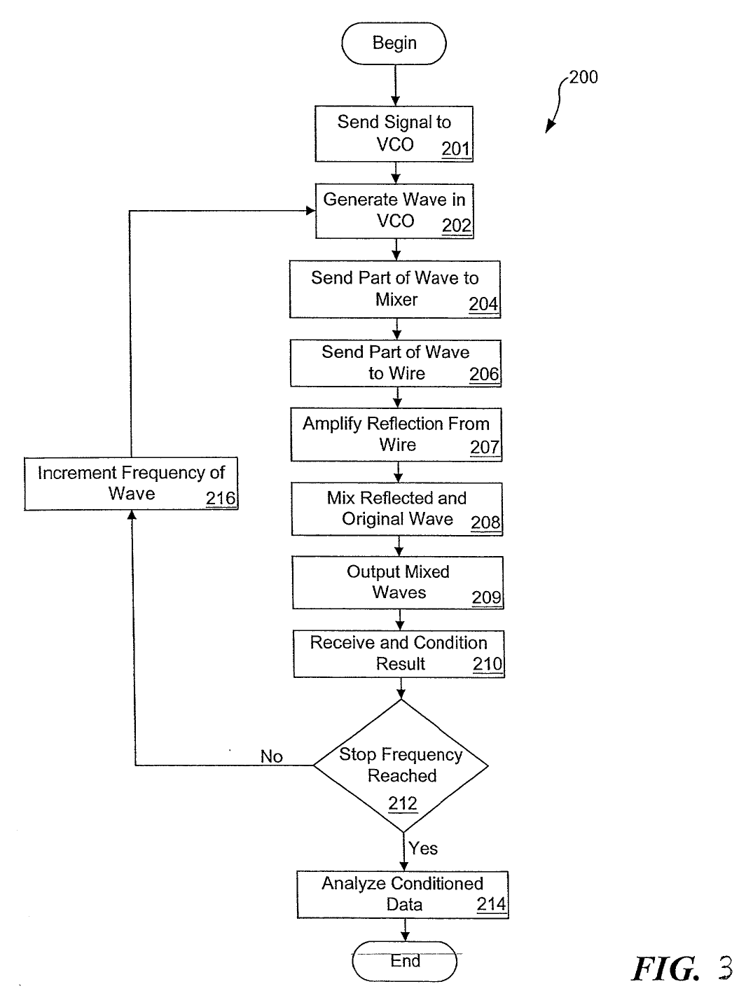

FIG. 3 is a flowchart that helps to describe the flow of the process performed by the FDR cable testing system described in FIG. 2. The method 200 begins with step 201 by transmitting a command signal from the personal computer 102 to the VCO 104 indicating the frequency of the sine wave to be generated by the VCO. The command signal transmitted in step 201 is received by the VCO 104 which then generates the sine wave of the required frequency in step 202. A power divider 106 then divides the sine wave generated in step 202 so that it is sent to both the mixer 114 in step 204 and to the CUT 110 in step 206.

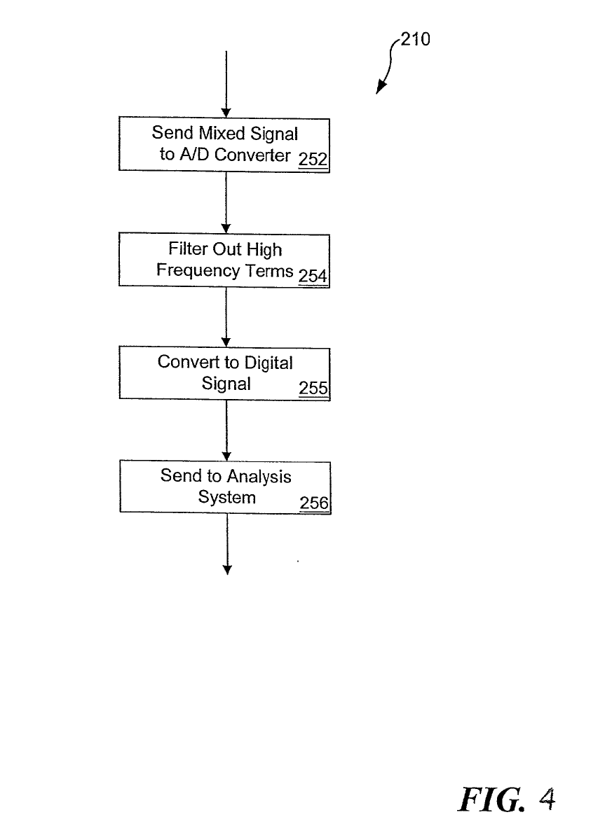

The input signal travels down the CUT 110 until it encounters either the open circuit or the short circuit and is reflected from the open or short circuit. The reflected input signal is then amplified by the optional amplifier 112 in step 207 and sent to the mixer 114. In step 208, the mixer 114 combines the original input signal and the reflected input signal. In step 210, the mixed signals are received by the A/D converter 116 and conditioned. The method of FIG. 3 is now interrupted in order to review the conditioning process 210 in more detail in FIG. 4.

FIG. 4 shows that the output of the mixer 114 is actually three mixed signals. The mixed signals are the original input signal, the sum of the input signal and the reflected input signal, and the difference of the input signal and the reflected input signal. These three mixed signals are sent to the A/D converter 116 in step 252. The A/D converter 116 filters out the high frequency components of the three mixed signals in step 254. The results of this are that the input signal and the sum of the input signal and the reflected input signal are dropped. The remaining DC signal, which is the difference between the input signal and the reflected input signal, is converted to a digital voltage (referred to as a digital signal hereinafter) in step 255. The digital signal is transmitted to the personal computer 102 in step 256.

The digital signal which is the difference between the input signal and the reflected input signal is a DC signal having a voltage that is dependent upon the frequency of the original input signal, the length of the CUT 110, and the point of termination of the CUT 110.

Returning now to FIG. 3, the method 200 next determines if a predetermined stop frequency has been reached in step 214. A stop frequency is whatever frequency that has been determined that the VCO 104 will not go beyond when generating the input signal, or in other words, the frequency of the sine wave. If the predetermined stop frequency has not been reached, the frequency of the sine wave to be transmitted as the new input signal is incremented in step 216, also according to a predetermined step frequency value that is recorded in the personal computer 102. The personal computer 102 sends a new frequency for the input signal to be generated by the VCO 104, and the method 200 begins again at step 202 until the predetermined stop frequency is reached.

In one preferred embodiment, a starting frequency that is transmitted from the personal computer 102 to the VCO 104 is 800 MHz, a stop frequency is 1.2 GHz, and a step frequency, by which the input signal will be incremented through each iterative run through the method 200 until reaching the stop frequency, is 10 MHz. As indicated in step 214, the personal computer analyzes the data to determine characteristics of the CUT 110. The values given above may change so should not be considered limiting, but they are provided as one possible set of frequency values that can work for many cables.

It is noted that other frequency bands have been used, beginning at 200, 300 and 400 MHz. Experimentation is proceeding with 50 MHz frequency bands. Lower frequency bands do provide benefits to the system.

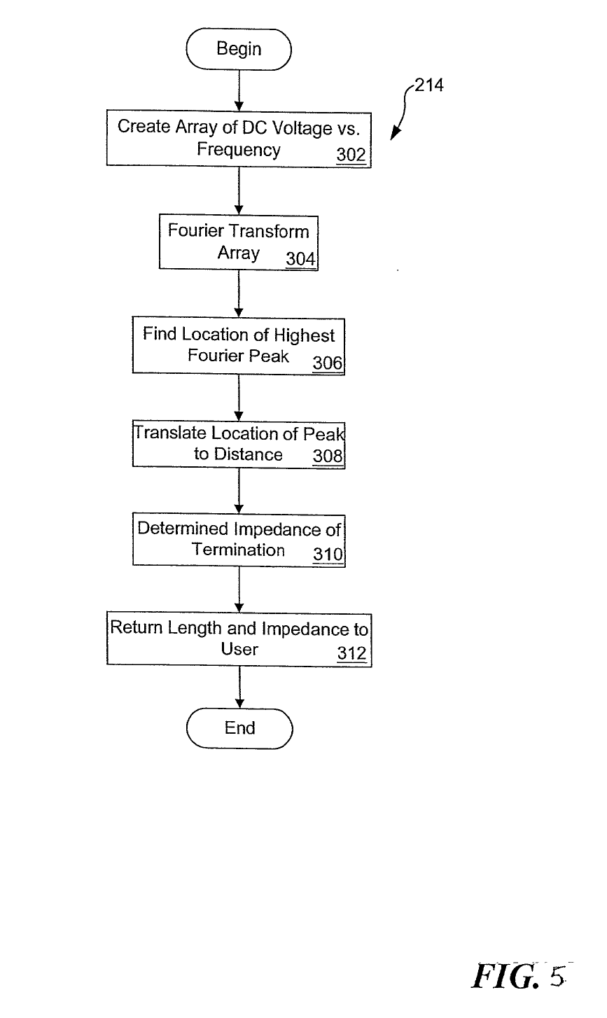

FIG. 5 is a flowchart of a method 300 of analyzing the digital signal received by the personal computer 102 from the A/D converter 116 in FIG. 2. The A/D converter 116 will send a plurality of digital signals to the personal computer 102, one digital signal for each of the frequencies used as input signals by the VCO 104. In step 302, the plurality of digital signals are stored in a memory array in the personal computer 102. Once the FDR cable testing system 100 has completed stepping through a desired range of frequencies, the stored data is processed in step 304.

In one embodiment, the step of processing begins by indexing the array by frequency of the input signal vs. the DC response at that frequency. This indexing creates a table of the DC response of the CUT 110 at all of the stepped input frequencies. The array created in step 302 is then transformed using the Fast Fourier Transform (FFT) by the personal computer 102 in step 304.

The FFT of the array in step 304 creates a Fourier signal having a given magnitude. The location of the peak of the Fourier signal having the greatest magnitude is then determined in step 306. The location of the highest peak is then translated to a distance along the CUT 110 where the point of termination occurred. In so doing, the location of the termination of the CUT 110 is given by equation 1, where L is the length of the cable to the point of termination, u is the velocity of propagation of the wave in the cable, wherein N is the number of cycles of the digital signal as a function of frequency, and ƒBW is the bandwidth in Hertz of the sampling range.

$$\text{Equation 1:} \\ L = \frac{u N}{2 {f}_{B W}}$$

Once the location of the point of termination has been determined in step 308, the nature of the point of termination can be determined in step 310. This is found by determining the impedance of the point of termination. A small impedance indicates a short circuit, while a large impedance indicates an open circuit. In order to calculate impedance at the point of termination, equations 2 and 3 are utilized.

$$\text{Equation 2:}$$

$${Z}_{i n} = {Z}_{0} \frac{( p + 1 )}{( p - 1 )}$$

$$\text{Equation 3:} \\ {Z}_{L} = \frac{{Z}_{0} ( {Z}_{i n} - {jZ}_{0} tan β l )}{( {Z}_{0} - {jZ}_{i n} tan β l )}$$

In equations 2 and 3, Zin is the input impedance of the system, p is the complex reflection coefficient of the CUT 110, Z0 is the impedance at the point of termination of the CUT 110, and l is the length of the CUT 110 as found in step 308. By solving equation 2 for Zin and then solving equation 3 for ZL the impedance of the termination of the CUT 110 may be determined. The length of the CUT 110 and the impedance at the point of termination of the wire are then returned to the user in step 312.

One advantage of the embodiments of the present invention is that the FDR cable testing systems are portable. In other words, the cable testing may be performed using an ordinary laptop or notebook computer as the personal computer 102, and thus taken on-site to conduct cable testing. The flexibility of the system becomes quite clear after realizing that an aircraft does not have to be returned to a hangar, but can be analyzed wherever it is located.

When the personal computer 102 is replaced by a microprocessor, the cable testing system becomes a compact in situ device.

It is also mentioned that integrity of a cable can be determined by comparing results when the cable is known or assumed to be good, and results taken afterwards.

The specification above has concerned itself exclusively with the most basic concepts of the invention regarding the use of FDR for cable testing systems. However, there are many ways that this invention can be used. This document explains some of alternative aspects of the invention.

One of the first novel aspects of the invention pertains to how it is used for testing. In other words, it is considered to be a novel aspect of the invention to provide in-situ cable and wire testing systems including in-connector, in-cable, smart-wire, wired or wireless, and passive or direct testing capabilities. The invention also teaches utilizing passive connectivity wherein a continuous connection for the original signal is maintained without interruption, even if the testing circuitry should fail. The present invention also teaches a system for testing of live cables by utilizing spread-spectrum signal techniques. Finally, cable fray detection is possible by looking for a specific frequency signature that is indicative of cable fray.

Beginning with an in-situ wire integrity FDR system, this embodiment is installed, for example, into an airplane and remains in place for the life of the aircraft. The system is a smart connector, or in-connector system. Consider two cables that either mate together, or mate at a junction box. The smart connector contains all of the necessary electronics for FDR integrity testing to detect open circuits and short circuits in the cables.

Other applications of the present invention are the ability to detect fraying or chafing of insulation on a cable, the ability to detect cracking or brittle insulation, and pinholes in insulation. These conditions are detectable because of a signature that can be found in the digital signal returned to the personal computer.

It is also important to recognize that the aviation industry is not the only industry that is seeking for a system that can provide quick, accurate and inexpensive cable testing technology. These other industries include the entire communications industry including the computer network industry, the automotive industry, the medical device industry, the home and commercial maintenance and building industry, the ship building and maintenance industry, the train industry, the space industry, the industrial building industry, and the nuclear industry, to name but a few specific but very large entities that can benefit from the present invention.

The FDR cable testing system could also be the technology applied to a measurement system that is coupled to an antenna that is being used to perform impedance measurements when performing materials sensing.

Another in-situ embodiment is to provide the FDR electronic circuitry directly inside the cable insulation itself, or in-cable. This is possible because the electronics can be as small as a pea. Other in-situ embodiments include a smart wire, where the material of the wire itself is providing the data. For example, there are many materials that could be used that are temperature sensitive, strain sensitive, etc. Using these materials as the cable insulation can generate data. Another option is to dispose a sensing wire around the outside of the main wire. If the sensing wire becomes frayed or an open circuit, it is a warning about the main wire. The system may be passive or active, and coupled to some alarm system through a wired or wireless connection.

One concern about an in-connector system is that the FDR electronics may be in the direct signal path. Thus, if the electronics were to fail, the signal might be blocked when the wire itself is still good. Thus, passive connectivity allows the signal path to remain intact regardless of the FDR system. But passive connectivity is still electrically active, so the signal will not be degraded by a failed FDR system.

Passive connectivity systems include an inductive connection, capacitive connection, and a cross talk connection. The capacitive connection operates well. The inductive connection is difficult to analyze, and the cross talk connection is not likely to function well, but it may be possible to overcome the initial difficulties.

It is also noted that a passive connectivity connection will also work for the other sensing technologies of SWR and TDR even though it has not been seen in the prior art.

Another important aspect of passive connectivity is that it is the only method of detection when testing lives cables. In other words, cables that are still in use will likely generate signals that will interfere with the FDR electronics, and vice versa. While even passive connectivity methods can cause interference, it is possible to minimize the effects. For example, a live DC cable will not interfere with an inductively coupled FDR system.

This passive connectivity has great potential to assist in troubleshooting of, for example, aircraft on the line. If a pilot or technician could push a single button and every wire bundle could be simultaneously tested while the aircraft is running would have a great impact on the aviation industry, and many others as well.

Another possible application would be to deploy a wire integrity system that would always be active. This could be particularly important when trying to track down and locate a “ticking” fault that appears, and then cannot be replicated because environmental conditions change, etc.

One aspect of the invention is to utilize spread spectrum. In other words, the high frequency signal of the FDR system could be reduced so that it is down enough into the noise so that it won't interfere with the signals of the particular system being tested which is live, and vice versa. Thus, a single frequency will not serve to jam the FDR system.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for determining integrity of a cable under test utilizing a cable testing system that uses frequency domain reflectometry (FDR), said method comprising the steps of:
(1) coupling the FDR cable testing system to a connecting end of the cable under test;
(2) transmitting at least one input signal from the FDR cable testing system to the cable under test;
(3) receiving a reflected input signal from the cable under test;
(4) mixing the at least one input signal and the reflected input signal to generate a DC signal; and
(5) processing the DC signal to thereby obtain data regarding integrity of the cable under test.

2. The method as defined in claim 1 wherein the step of obtaining data regarding integrity of the cable under test further comprises the step of determining impedance of the cable under test at a point of termination thereof.

3. The method as defined in claim 2 wherein the method further comprises the steps of:
(1) determining if the cable under test has a short circuit at the point of termination, wherein a short circuit is indicated by a small impedance value at the point of termination; and
(2) determining if the cable under test has an open circuit at the point of termination, wherein an open circuit is indicated by a large impedance value at the point of termination.

4. The method as defined in claim 3 wherein the method further comprises the step of determining a length of the cable under test from the connecting end to the point of termination.

5. The method as defined in claim 4 wherein the method of determining a length of the cable under test further comprises the step of mixing the at least one input signal and the reflected input signal to thereby generate a mixed signal having at least three components.

6. The method as defined in claim 5 wherein the method further comprises the steps of:
(1) generating the sum of the at least one input signal and the reflected input signal;
(2) generating the difference of the at least one input signal and the reflected input signal; and
(3) generating the at least one input signal, wherein the three components form the mixed signal.

7. The method as defined in claim 6 wherein the method further comprises the step of filtering out high frequency components from the mixed signal.

8. The method as defined in claim 7 wherein the method further comprises the steps of:
(1) dropping the sum of the at least one input signal and the reflected input signal;
(2) dropping the at least one input signal; and
(3) converting the difference of the at least one input signal and the reflected input signal which is an analog direct current (DC) voltage signal to a digital signal.

9. The method as defined in claim 8 wherein the method further comprises the steps of:
(1) generating a plurality of input signals, wherein the plurality of input signals are utilized to generate a plurality of digital signals;
(2) storing the plurality of digital signals in an array, wherein a frequency of each of the plurality of input signals is associated with a corresponding digital signal that is generated thereby;
(3) performing a Fast Fourier Transform (FFT) on each of the plurality of digital signals to thereby generate a plurality of Fourier signals, one for each of the plurality of digital signals, and wherein each of the plurality of Fourier signals has a given magnitude;
(4) determining which of the plurality of Fourier signals has a greatest magnitude; and
(5) translating the Fourier signal having the greatest magnitude to a distance along the cable under test relative to the connecting end, thereby determining a length of the cable under test to the point of termination.

10. The method as defined in claim 9 wherein the method further comprises the step of calculating the length of the cable under test utilizing the equation
$$L = \frac{u N}{2 {f}_{B W}} ,$$
wherein L is the length of the cable under test to the point of termination, wherein u is the velocity of propagation of the input signal in the cable under test, wherein N is the number of cycles in the digital signal, and wherein ƒBW is the bandwidth in Hertz of a sampling range.

11. The method as defined in claim 10 wherein the step of determining impedance of the cable under test at the point of termination further comprises the step of solving the
$$equations {Z}_{i n} = {Z}_{0} \frac{( p + 1 )}{( p - 1 )} and {Z}_{L} = \frac{{Z}_{0} ( {Z}_{i n} - {jZ}_{0} tan β l )}{( {Z}_{0} - {jZ}_{i n} tan β l )} ,$$
to thereby determine an input impedance of the cable under test, wherein Zin is the input impedance of the cable under test, p is the complex reflection coefficient of the cable under test, Z0 is the impedance at the point of termination of the cable under test, l is the length of the cable under test, and ZL is the impedance of the termination of the cable under test.

12. The method as defined in claim 11 wherein the step of transmitting the at least one input signal from the FDR cable testing system to the cable under test further comprises the steps of:
(1) providing a personal computer, wherein the personal computer generates a command signal containing a predetermined frequency for a sine wave; and
(2) providing a voltage controlled oscillator (VCO), wherein the VCO receives the command signal and generates the sine wave of the predetermined frequency value to thereby produce the input signal.

13. The method as defined in claim 12 wherein the method further comprises the steps of:
(1) providing a power divider, wherein the power divider splits the input signal;
(2) providing a mixer, wherein the mixer receives the input signal that is split by the power divider; and
(3) providing the cable under test, wherein the cable under test also receives the input signal that is split by the power divider.

14. The method as defined in claim 13 wherein the method further comprises the steps of:
(1) transmitting the reflected input signal from the point of termination of the cable under test to a directional coupler;
(2) transmitting the reflected input signal from the directional coupler to an amplifier; and
(3) amplifying the reflected input signal to thereby have a magnitude that is approximately the same as the input signal that was transmitted to the mixer.

15. The method as defined in claim 14 wherein the method further comprises the steps of:
(1) mixing the input signal received from the power divider and the reflected and amplified input signal received from the amplifier; and
(2) generating the mixed signal as defined in claim 6.

16. The method as defined in claim 15 wherein the method further comprises the steps of:
(1) filtering high frequency components from the mixed signal;
(2) digitizing the analog mixed signal; and
(3) transmitting the digitized signal to the personal computer for storage in the array of claim 9.

17. The method as defined in claim 16 wherein the method further comprises the steps of:
(1) generating the command signal that contains the first frequency for the VCO to generate;
(2) receiving the digital signal from the A/D converter;
(3) adding a stepped input frequency to a previous frequency transmitted to the VCO to generate a new frequency for the VCO to generate;
(4) transmitting the new frequency to the VCO in a new command signal; and
(5) repeating steps (2) through (4) until the new frequency is equal to or greater than a predetermined stop frequency.

18. The method as defined in claim 17 wherein the method further comprises the step of utilizing the personal computer to analyze the array after the stop frequency is reached in order to determine the length of the cable under test, and an impedance of the cable under test, to thereby determine if the cable under test ends in a short circuit or an open circuit.

19. A cable testing system that utilizes principles of frequency domain reflectometry (FDR) to thereby determine characteristics of a cable under test (CUT), said cable testing system comprising:
a voltage controlled oscillator (VCO) for generating an input signal;
a power divider for receiving the input signal from the VCO and dividing the input signal;
a mixer for receiving the input signal from the power divider;
wherein the CUT also receives the input signal from the power divider, and generates a reflected input signal, and wherein the mixer receives the input signal and the reflected input signal to thereby generate a mixed signal having at least two components;
an analog to digital (A/D) converter for receiving the mixed signal and filtering out high frequency components therefrom, and for generating a digital signal, wherein the digital signal contains a signal that is dependent upon a frequency of the input signal, a length of the CUT, and of a point of termination of the CUT; and
a processor for utilizing the digital signal to thereby determine characteristics of the cable under test.

20. The cable testing system as defined in claim 19 wherein the cable testing system further comprises a computer, wherein the computer controls the VCO and performs calculations to thereby determine the characteristics of the cable under test.

21. The cable testing system as defined in claim 20 wherein the cable testing system further comprises:
a directional coupler for receiving the reflected input signal from the CUT; and
an amplifier for receiving the reflected input signal from the directional coupler and amplifying the reflected input signal, wherein the amplifier transmits the reflected input signal to the mixer.

22. A method for determining characteristics of a cable under test utilizing a cable testing system that uses principles of frequency domain reflectometry (FDR), said method comprising the steps of:
(1) providing a signal generator for generating a sine wave, a power divider coupled to signal generator at an input, and to a mixer and the cable under test at two outputs, wherein the mixer is also coupled at another input to the cable under test for receiving a reflected sine wave therefrom, and at an output to an input of an analog to digital (A/D) converter, wherein the A/D converter is coupled at an output to a processor;
(2) transmitting a sine wave from the signal generator to the cable under test and to the mixer via the power divider;
(3) receiving a reflected sine wave from the cable under test at the mixer;
(4) mixing the sine wave and the reflected sine wave to generate a DC signal from the mixer;
(5) processing the DC signal to thereby obtain data regarding impedance and length of the cable under test;
(6) changing a frequency of the sine wave;
(7) performing steps (2) through (6) a predetermined number of times to thereby generated a plurality of DC signals; and
(8) determining impedance and length of the cable under test utilizing the plurality of DC signals.

23. The method as defined in claim 22 wherein the method further comprises the step of mixing the sine wave and the reflected sine wave to thereby generate a mixed signal having at least two components.

24. The method as defined in claim 23 wherein the method further comprises the steps of:
(1) generating the sum of the sine wave and the reflected sine wave;
(2) generating the difference of the sine wave and the reflected sine wave; and
(3) generating the sine wave, wherein the sum, different and original sine wave for three components of the mixed signal.

25. The method as defined in claim 24 wherein the method further comprises the step of filtering out high frequency components from the mixed signal.

26. The method as defined in claim 25 wherein the method further comprises the steps of:
(1) dropping the sum of the sine wave and the reflected sine wave;
(2) dropping the at least one input signal; and
(3) converting the difference of the sine wave and the reflected sine wave, which is an analog direct current (DC) voltage signal, to a digital signal, wherein a plurality of digital signals are generated by the plurality of sine waves.

27. The method as defined in claim 26 wherein the step of determining impedance and length of the cable under test further comprises the step of determining impedance of the cable under test at a point of termination thereof.

28. The method as defined in claim 27 wherein the method further comprises the steps of:
(1) determining if the cable under test has a short circuit at the point of termination, wherein a short circuit is indicated by a small impedance value at the point of termination; and
(2) determining if the cable under test has an open circuit at the point of termination, wherein an open circuit is indicated by a large impedance value at the point of termination.

29. The method as defined in claim 28 wherein the method further comprises the steps of:
(1) storing the plurality of digital signals in an array, wherein a frequency of each of the plurality of sine waves is associated with a corresponding digital signal that is generated thereby;
(2) performing a Fast Fourier Transform (FFT) on each of the plurality of digital signals to thereby generate a plurality of Fourier signals, one for each of the plurality of digital signals, and wherein each of the plurality of Fourier signals has a given magnitude;
(3) determining which of the plurality of Fourier signals has a greatest magnitude; and
(4) translating the Fourier signal having the greatest magnitude to a distance along the cable under test, thereby determining a length of the cable under test to the point of termination.

30. The method as defined in claim 29 wherein the method further comprises the step of calculating the length of the cable under test utilizing the equation
$$L = \frac{u N}{2 {f}_{B W}} ,$$
wherein L is the length of the cable under test to the point of termination, wherein u is the velocity of propagation of the sine wave in the cable under test, wherein N is the number of cycles of the digital signal as a function of frequency, and wherein ƒBW is the bandwidth in Hertz of a sampling range.

31. The method as defined in claim 30 wherein the step of determining impedance of the cable under test at the point of termination further comprises the step of solving the
$$equations {Z}_{i n} = {Z}_{0} \frac{( p + 1 )}{( p - 1 )} and {Z}_{L} = \frac{{Z}_{0} ( {Z}_{i n} - {jZ}_{0} tan β l )}{( {Z}_{0} - {jZ}_{i n} tan β l )} ,$$
to thereby determine an input impedance of the cable under test, wherein Zin is the input impedance of the cable under test, p is the complex reflection coefficient of the cable under test, Z0 is the impedance at the point of termination of the cable under test, l is the length of the cable under test, and ZL is the impedance of the termination of the cable under test.

32. The method as defined in claim 31 wherein the method further comprises the steps of:
(1) providing a personal computer, wherein the personal computer generates a command signal containing a predetermined frequency for the sine wave; and
(2) providing a voltage controlled oscillator (VCO) as the signal generator, wherein the VCO receives the command signal and generates the sine wave of the predetermined frequency value.

33. The method as defined in claim 32 wherein the method further comprises the steps of:
(1) transmitting the reflected sine wave from the point of termination of the cable under test to a directional coupler;
(2) transmitting the reflected sine wave from the directional coupler to an amplifier; and
(3) amplifying the reflected sine wave to thereby have a magnitude that is approximately equal to that of the sine wave that was transmitted to the mixer.

34. The method as defined in claim 33 wherein the method further comprises the step of utilizing the personal computer to analyze the array after no more sine waves are being generated in order to determine the length of the cable under test, and an impedance of the cable under test, to thereby determine if the cable under test ends in a short circuit or an open circuit.
